(19) United States
(12) Patent Application Publication
(10) Pub. No.: US 2011/0082896 A1
(43) Pub. Date: Apr. 7, 2011

(54) Dynamically Updated Web-Enabled and Embedded Contact Address in Communication Devices

(75) Inventors: Saurabh Kumar, Jersey City, NJ (US); Mina Awad, Edison, NJ (US); Piyush Anoop Doshi, Marlboro, NJ (US); Bhavin A. Doshi, Marlboro, NJ (US)

(73) Assignee: AT&T INTELLECTUAL PROPERTY I, L.P., Reno, NV (US)

(21) Appl. No.: 12/575,013

(22) Filed: Oct. 7, 2009

(51) Int. Cl. G06F 15/16; H04M 3/42

(52) U.S. Cl. 709/202; 455/414.2

(57) ABSTRACT

Systems and methods for seamless automated updating of a subscriber's address book based on relationships or “links” created between a subscriber and their contacts. The contacts are stored in a centralized addressbook database, and any updates to a subscriber's profile or record within the database results in an update to each of the subscriber's contacts' local address books stored on the contacts' devices. The system includes communication devices on a network being associated with subscribers of the network and an application server hosting an addressbook application, the application server having linking logic that creates a link between the subscribers where a modification of the first address on the addressbook database by the first subscriber results in a subsequent modification of the first address within a local copy of the addressbook database stored on a memory on the second device associated with the second subscriber.

### BACKGROUND OF THE INVENTION

1. Field of the Invention

The present invention relates to mobile communication devices. More particularly, the present invention relates to revising and populating address book entries on a mobile communication device.

2. Background of the Invention

The development of cellular communication networks permits network subscribers to make and receive calls, send and receive email messages and short message service messages, send and receive faxes, and perform other communication tasks while at a fixed location or while mobile. Thus, a subscriber need not remain at a particular home or business address in order to remain accessible for personal or business communications. For example, a network subscriber can configure a mobile office so that the subscriber can send and receive typical business and personal communications, even while mobile. For example, a realtor can configure an automobile with a fax machine, a laptop computer, a personal digital assistant or handheld computer, and a cellular telephone or other mobile station. As a result, the realtor need not return to an office regularly, increasing her availability for client contact. Other subscribers can take advantage of mobile communications to remain in touch with friends and family, even while traveling.

While mobile communication systems offer numerous advantages, management of necessary contact information can be difficult. Access to a stored customer/contact database is typically unavailable, so that obtaining contact data such as phone numbers and addresses is difficult. Methods and apparatus are needed that permit network subscribers to access and revise contact data while mobile.

### SUMMARY OF THE INVENTION

The present invention solves the above-identified problems by providing systems and methods for seamless automated updating of a subscriber's address book based on relationships or “links” created between a subscriber and their contacts. The contacts are stored in a centralized addressbook database, and any updates to a subscriber's profile or record within the database results in an update to each of the subscriber's contacts' local address books stored on the contacts' devices.

In one embodiment, the present invention is a system for automatically updating an address for a subscriber, including a first communication device on a network, the first communication device being associated with a first subscriber of the network and having a first address on the network, a second communication device on the network, the second communication device being associated with a second subscriber of the network and having a second address on the network, an application server on the network that hosts an addressbook application, the application server being in communication with an addressbook database on the network, wherein the addressbook database stores at least the first and second addresses and associates them with the first and second subscribers, and linking logic on the application server that creates a link between the first and second subscriber based on a communication between the first and second subscriber. A modification of the first address on the addressbook database by the first subscriber results in a subsequent modification of the first address within a local copy of the addressbook database stored on a memory on the second device associated with the second subscriber.

The addressbook database on the network comprises a plurality of records for a plurality of subscribers on the network, each record having a plurality of addresses for a plurality of devices associated with a subscriber of the network, each record further having a unique identifier for the subscriber of the network. The unique identifier is any combination of: an email address, a social security number, a first and a last name, and a date of birth.

The linking logic creates the link by modifying the addressbook database on the network, the modification including adding the unique identifier of the second subscriber in a contact field in the record for the first subscriber, and adding the unique identifier of the first subscriber in a contact field in the record for the second subscriber. The modification of the first address is performed via a local copy of the addressbook application stored on a memory on the first device. Alternatively, the modification of the first address is performed via a web interface. The subsequent modification of the local copy of the addressbook database is performed by an updating logic on the application server, the updating logic modifying the local copy of the addressbook database over the network. Alternatively, the subsequent modification of the local copy of the addressbook database is performed by an updating logic on the second mobile device, the updating logic modifying the local copy of the addressbook database by retrieving the updated addressbook database from the network.

In another exemplary embodiment, the present invention is a method for automatically updating an address for a contact, the method including storing a first record for a first subscriber on a network and a second record for a second subscriber on the network, the first and second records being stored in an addressbook database in communication with an application server on the network, wherein each record includes at least a unique identifier for the subscriber on the network, and an address of a device associated with the corresponding subscriber on the network, creating a link between a first subscriber and the second subscriber based upon a communication between a first address of a first device associated with the first subscriber and a second address of a second device associated with the second subscriber, modifying the record for the first subscriber on the addressbook database on the network, and subsequently modifying a record for the first subscriber on a local copy of the addressbook database stored on a memory within the second device associated with the second subscriber.

In another exemplary embodiment, the present invention is a computer program product stored on a computer readable medium on a network, the computer program product embodying logic that performs the steps of storing a first record for a first subscriber on a network and a second record for a second subscriber on the network, the first and second records being stored in an addressbook database in communication with an application server on the network, wherein each record includes at least a unique identifier for the subscriber on the network, and an address of a device associated with the corresponding subscriber on the network, creating a link between a first subscriber and the second subscriber based upon a communication between a first address of a first device associated with the first subscriber and a second address of a second device associated with the second subscriber, modifying the record for the first subscriber on the addressbook database on the network, and subsequently modifying a record for the first subscriber on a local copy of the addressbook database stored on a memory within the second device associated with the second subscriber.

These and other examples are described below with reference to the accompanying drawings.

### BRIEF DESCRIPTION OF THE DRAWINGS

FIG. 1 shows a system for updating an addressbook database, according to an exemplary embodiment of the present invention.

FIGS. 2A and 2B show a mobile communication device with a local addressbook database, according to an exemplary embodiment of the present invention.

FIG. 3 shows an addressbook application on a subscriber's device, according to an exemplary embodiment of the present invention.

FIG. 4 shows a method for creating a link between two subscribers, according to an exemplary embodiment of the present invention.

FIGS. 5A and 5B show methods for updating an addressbook, according to an exemplary embodiment of the present invention.

### DETAILED DESCRIPTION OF THE INVENTION

The following detailed description discloses systems and methods for automated updating of an addressbook on a communication device associated with a subscriber of a network. The subscriber initially registers his identity and his one or more communication devices with a server on the network, the server being in communication with an addressbook database on the network. The subscriber then initiates a communication with a second subscriber of the network. The communication may be a link request. If the second subscriber has registered with the addressbook server, the second subscriber is able to approve the link request. Link logic within the server updates the records on the addressbook database to reflect the relationship between the subscriber and the second subscriber. Thereafter, any time one subscriber updates his personal record on the addressbook, the update is either “pushed” to the linked contacts of the subscriber, or alternatively, the linked contacts regularly “pull” updated data from the addressbook database on the network. Since each communication device preferably has a local addressbook database stored on a memory within the device, the local addressbook is frequently updated with the changes in the network addressbook database. Consequently, both network and local addressbook databases are synchronized with minimal effort on the part of the subscribers.

For the purposes of the present disclosure, “Communications device”, as used herein refers to any device capable of wirelessly sending and receiving data. Examples of a handheld communications device include cellular telephones, personal digital assistants (PDAs), laptop computers, portable music devices having wireless technology, etc. Communication devices typically have, inter alia, a memory and a processor. The memory stores applications, software, or “logic” in the form of a computer program readable by the processor. “Logic”, as used herein and throughout this disclosure, refers to any information having the form of instruction signals and/or data that may be applied to affect the operation of a processor. Examples of processors are computer processors (processing units), microprocessors, digital signal processors, controllers and microcontrollers, etc. Logic may be formed from signals stored in a device memory. Software is one example of such logic. Examples of device memories that may comprise logic include RAM (random access memory), flash memories, ROMS (read-only memories), EPROMS (erasable programmable read-only memories), and EEPROMS (electrically erasable programmable read-only memories). Logic may also be comprised by digital and/or analog hardware circuits, for example, hardware circuits comprising logical AND, OR, XOR, NAND, NOR, and other logical operations. Logic may be formed from combinations of software and hardware.

“Smart card”, as used herein and throughout this disclosure, refers to a card with integrated circuits and including a memory and a processor and may be read by an electronic device. Smart cards are similar to memory cards in that they have a memory and can be read by electronic devices. However, smart cards differ in that they include a processor. Smart cards are often equipped with logic to require authentication before revealing the contents of its memory. Examples of smart cards include Integrated Circuit Cards (ICC), Universal ICCs (UICC), Subscriber Identity Module (SIM) cards, etc., and combinations thereof.

Communication devices communicate with each other and with other elements via a communication network, for instance, a wireless network, or a wireline network. Networks can include broadband wide-area networks or local-area networks. Communication across a network is preferably packet-based, however, radio and frequency/amplitude modulations networks can enable communication between communication devices using appropriate analog-digital-analog converters and other elements.

A network typically includes a plurality of servers that host logic for performing tasks on the network. In modern packet-based wide-area networks, servers may be placed at several logical points on the network. An example of a server is an Application Server that hosts an application for remote communication devices to access via the network. Application servers may be in communication with databases and can enable communication devices to access the contents of a database. Other examples of servers include but are not limited to proxy and authentication servers, billing servers, etc.

For the following description, it can be assumed that most correspondingly labeled structures across the figures (e.g., 132 and 232, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

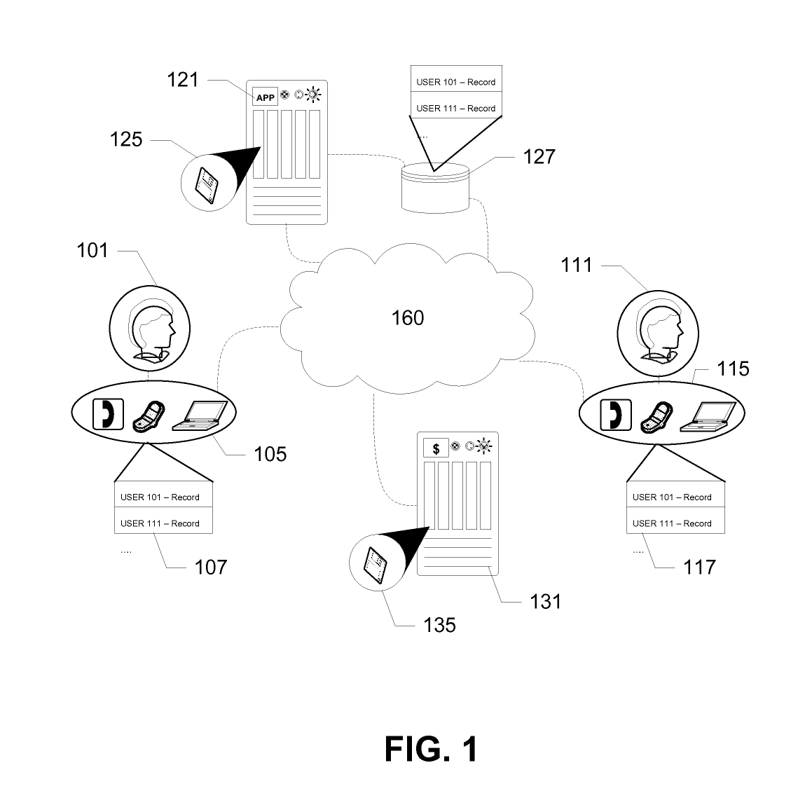

FIG. 1 shows a system for updating an addressbook database, according to an exemplary embodiment of the present invention. A first subscriber 101 owns or is associated with one or more communication devices 105. Devices 105 include regular telephones, mobile telephones, network-enabled personal computers, etc. Devices 105 further include a memory that is capable of storing a local copy of an addressbook database 107. Devices 105 communicate with network 160. Similarly, FIG. 1 shows a second subscriber 111, associated with communication devices 115 having stored therein addressbook database 117. As mentioned earlier, network 160 can be a mobile broadband network such as a 3G network. Consequently, in this embodiment, there exists an application server 121, having stored therein one or more logic units 125, as well as a billing server 131, with logic 135. Further, there exists on the network, and preferably in communication with application server 121, a network addressbook database 127. Communication over network 160 occurs via a packet-based protocol such as TCP/IP, and may be initiated using the Session Initiation Protocol (SIP). Furthermore, each network element such as devices 107/117, and servers 121/131 have unique logical network addresses, such as a SIP or IP address, an MSISDN, a unique telephone number, etc. For the sake of simplicity, other network elements that may be used for inter-network communication are not shown in this figure. Examples include switching centers for mobile networks, a home location register (HLR) to provide storage for subscriber information such as subscriber MSISDNs and other permanent and temporary information associated with subscribers, and proxy and authentication servers that enable or restrict access to network features such as application server 121.

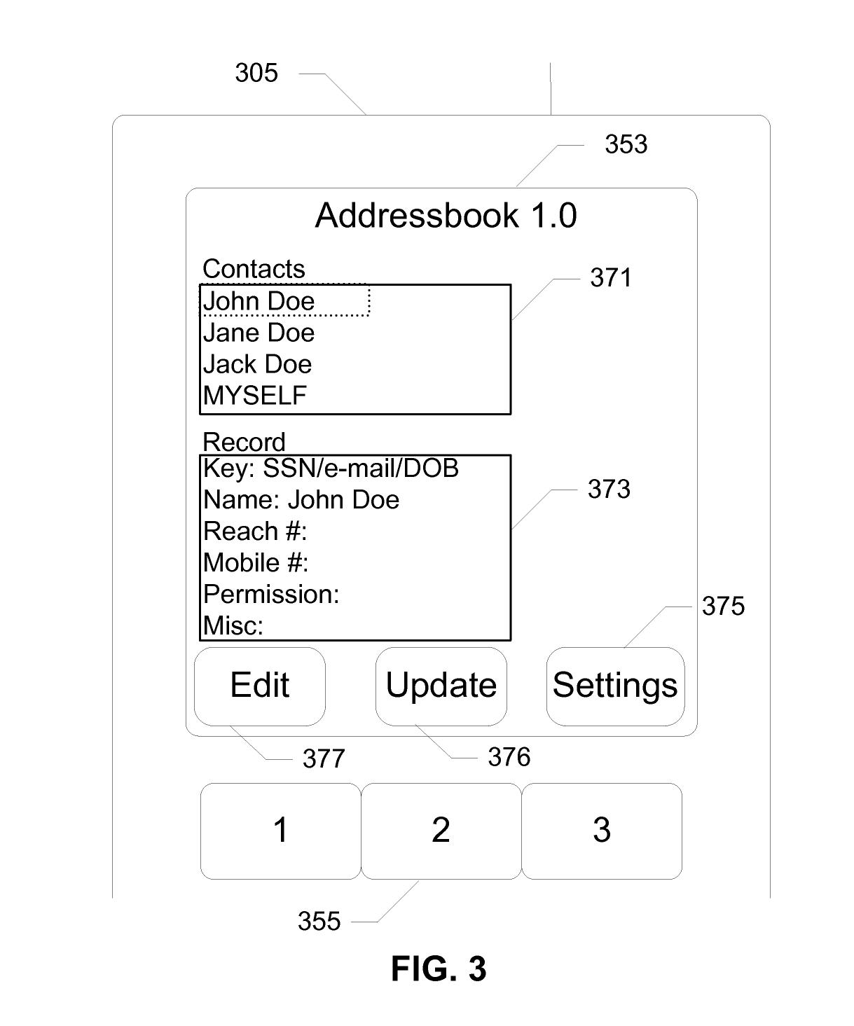

Application server 121 hosts an addressbook application, which includes a plurality of logic units represented by logic 125. Similarly, each of devices 105 and 115 are enabled to run a client or remote version of the addressbook application. The addressbook application on devices 105/115 allows a user 101/111 to remotely register and add their personal information to addressbook database 127 via application server 121. This can be performed, for example, via a user interface, such as the one described in FIG. 3. Addressbook 127 can be configured to store a variety of subscriber information such as contact names, phone numbers (including home, business, and cell phone numbers), fax numbers, email addresses, home and business addresses, web pages, and other personal or business information. Each record within addressbook 127 is associated with a particular subscriber, such as subscriber 101 and 111. Furthermore each record within addressbook 127 has a unique key or identifier for the subscriber, such as a unique username, social security number, combination of a date of birth and name, etc. A representative record is further described in FIG. 3.

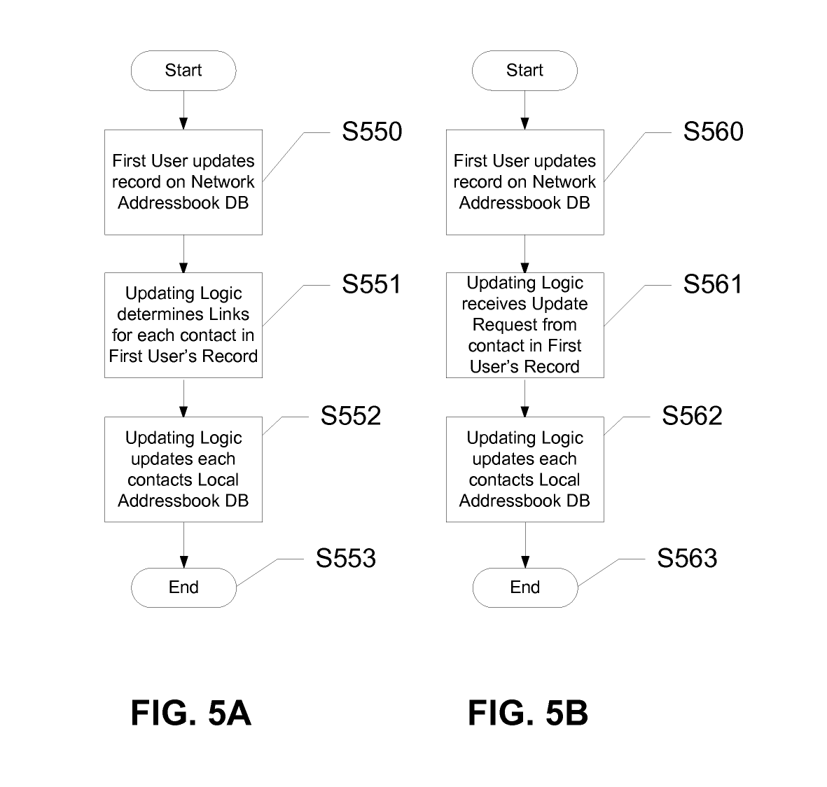

Addressbook 125 further includes information related to the relationships between a first subscriber 101 and a second subscriber 111. A feature of the present invention is that any updates to a subscriber's record in addressbook database 125 will result in a corresponding update to the local addressbook databases on every device owned by a subscriber who has a relationship with the first subscriber. The process of creating relationships and updating local addressbook databases is described in detail in FIGS. 5A and 5B. Briefly, subscriber 101 registers his information with application server via an application or web-based interface on his devices 105. Subscriber 101 then sends a message to subscriber 111 requesting the creation of a relationship. This message may be a text message, or any equivalent message that can be considered a “link request.” Subscriber 111 has the ability to accept or deny the link request, based on the preferences of subscriber 111. If subscriber 111 accepts the link request, linking logic within logic 125 is configured to receive origination information, destination information, and/or message characterization information pertaining to the link request. The linking logic can also receive a message indicator that identifies the message as a link request from billing server 131. In other embodiments, a message indicator can identify the message as a short message service message, a fax, an email, video, audio, or other message type. Linking logic processes the link request by updating the profiles of subscriber 101 to reflect a relationship or link with the unique user identity of subscriber 111. Alternatively, if subscriber 111 has not registered themselves with the application server 121, then subscriber 111 is prompted to register themselves and add a record corresponding to their devices in addressbook database 127.

Once it is established that both subscribers 101 and 111 have records within addressbook database 127, then linking logic within logic 125 updates each record to reflect the relationship with the other subscriber. This can also be considered a “permission” that allows one subscriber to access the record of the other subscriber. This concept is important for the ability to automatically update the local copies 107 and 117 of the addressbook database 127. For instance, if subscriber 101 decides to move to a new area code, or purchases a new device to add to his arsenal of devices 105, this new information can be updated by subscriber 101 in his profile or record in addressbook database 127. This update can be performed via the addressbook application on devices 105, or alternatively via a web interface that is accessed via devices 105. Logic 125 updates the record in addressbook database 127. Optionally a confirmation message can be relayed to subscriber 101 that the update is successful. In an alternate embodiment, a subscriber 101 who does not have an application or updating feature installed on his device 105 can still transmit updates and receive contact information from addressbook database 127 via text messages. The text message could be formatted in a specific way, such as a business card, such that the addressbook databases on the network and on the local memory can parse the message to retrieve updated contact information.

There exists updating logic within logic 125 on application server 120 that is programmed to review the record for subscriber 101 for all relationships/links that exist with other subscribers. If subscriber 101 is linked to subscriber 111 (as described above and in FIG. 5A) then the updating logic retrieves this link information from the record of subscriber 101, and updates the local copy of addressbook database 117 stored on devices 115 associated with subscriber 111. This can be achieved in two ways, both of which are described in FIGS. 5A and 5B. Briefly, the updating logic can access the addressbook 117 by accessing a SIM card, smart card, or equivalent module on devices 105, and amend the addressbook file to reflect the new changes by subscriber 101. Alternatively, subscriber 111 may have programmed his application on devices 115 to regularly download updated information from addressbook 127, in which case the next scheduled update will add the new information to local addressbook database 117. In this way, changes by one subscriber are automatically reflected in local address books of all other subscribers having links to the one subscriber.

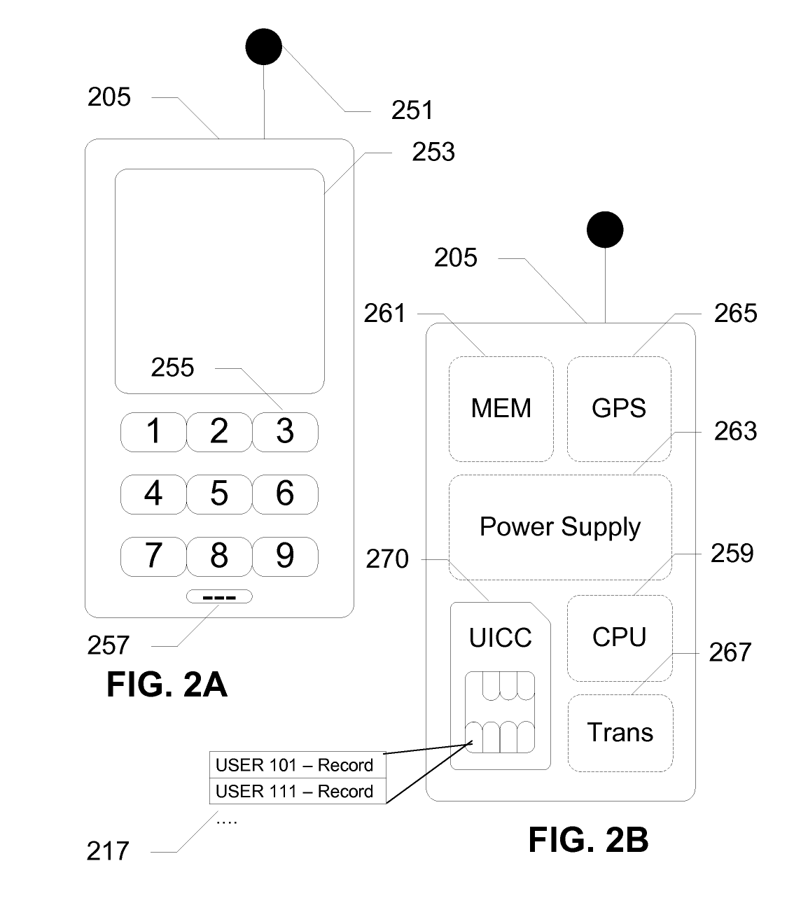

FIGS. 2A and 2B show a wireless communications device 220 having a smart card 270, according to an exemplary embodiment of the present invention. Referring to FIG. 2A, wireless communications device 205 includes common components of a cellular telephone such as display 253, keypad 255, microphone 257, and antenna 251. Display 253 is a Liquid Crystal Display (LCD) that serves as the visual output for the wireless communications device. Keypad 255 is a numerical keypad that serves as the physical input for user commands. The vast majority of the functions of wireless communications device 205 involve user input through keypad 255 and visual output through display 253. Microphone 257 serves as audio input for receiving a subscriber's voice for transmission across a network during a telephone call. Antenna 251 is the transmission and reception point for wireless communication of wireless communication device 205. In alternate embodiments, the display is a Light Emitting Diode (LED) screen. In further embodiments, the display is a touch-screen which may serve not only as visual output, but is capable of receiving physical input. In embodiments with a touch-screen as the display, a separate keypad as input may not be necessary.

FIG. 2B shows the internal components of a wireless communications device 205 having a smart card 270, according to an exemplary embodiment of the present invention. The components of wireless communications device 205 include a device memory 261, a device processor 259, a power supply 263, a Global Positioning System (GPS) module 265, and a wireless transceiver 267. Device memory 261 stores an operating system and other logic for using wireless communications device 205. Memory 261 also stores applications such as an addressbook application. Device memory 261 is in communication with device processor 259. Device processor 259 receives and routes data to and from the components of wireless communications device 205. Power supply 263 supplies electrical power to the components of wireless communications device 205 and also smart card 270 when it is coupled with wireless communications device 205. GPS module 265 is in communication with device processor 259 and communicates with satellites to determine the position of wireless communications device 205 anywhere on earth. Wireless transceiver 267 is in communication with device processor 259 and is responsible for communication with networks and other electronic devices.

Smart card 270 is coupled with wireless communications device 205 allowing device 205 to register with the network, and also stores authentication information. Smart card 270 also stores a local copy of addressbook database 217. Consequently, updating logic on the application server accesses smart card 270 to send updates from the network addressbook database to the local copy 217. Smart card 270 also interfaces with the addressbook application stored on memory 261, in order to send and receive updates to local addressbook database 217.

FIG. 3 shows an addressbook application on a communication device 305, according to an exemplary embodiment of the present invention. The user interface for the addressbook application is displayed on display 353, and on one screen, includes a contacts pane 371, a record window for the selected contact 373, and operational buttons 375, 376, and 377. In the example shown in FIG. 3, a subscriber has selected the contact John Doe, and the record for John Doe is shown in the record pane 373. Record pane 373 displays the unique key identifier which can be any combination of an SSN, email, date of birth, and name. Record pane 373 also shows the contact information for John Doe, including a Reach Number, which is the address that John Doe can most currently be reached at. A reach number can be programmed by John Doe using his own device, or alternatively, a reach number can be appended to the database by monitoring John Doe's usage statistics. Similarly, using the “settings” option, the current subscriber associated with device 305 can edit his own reach number to reflect the most current address. The reach number programmed into the communication device can therefore be used as a default call number for the contact, providing the functionality of a call-divert feature without the hassle of setting it up.

Using this application the user can update his own information using the “Edit” option 377. The subscriber can also update his local phonebook by using the “Update” option 376 which sends a request to the application server to download the latest updates to the network addressbook database. Alternatively, the subscriber can edit his settings 375 to automatically update the local addressbook at defined intervals. Moreover, the subscriber can view all the records that he is linked to, as well as all contacts that have the permission to update their own local addressbooks with the subscriber's updates. This is reflected in the “permission” field in record pane 373. The application can be configured so that only selected network subscribers are eligible to update their addressbooks with the subscriber's information. Eligibility can be determined by, for example, the relationship or link between subscribers, a subscriber's subscription type or other subscriber or network configurations.

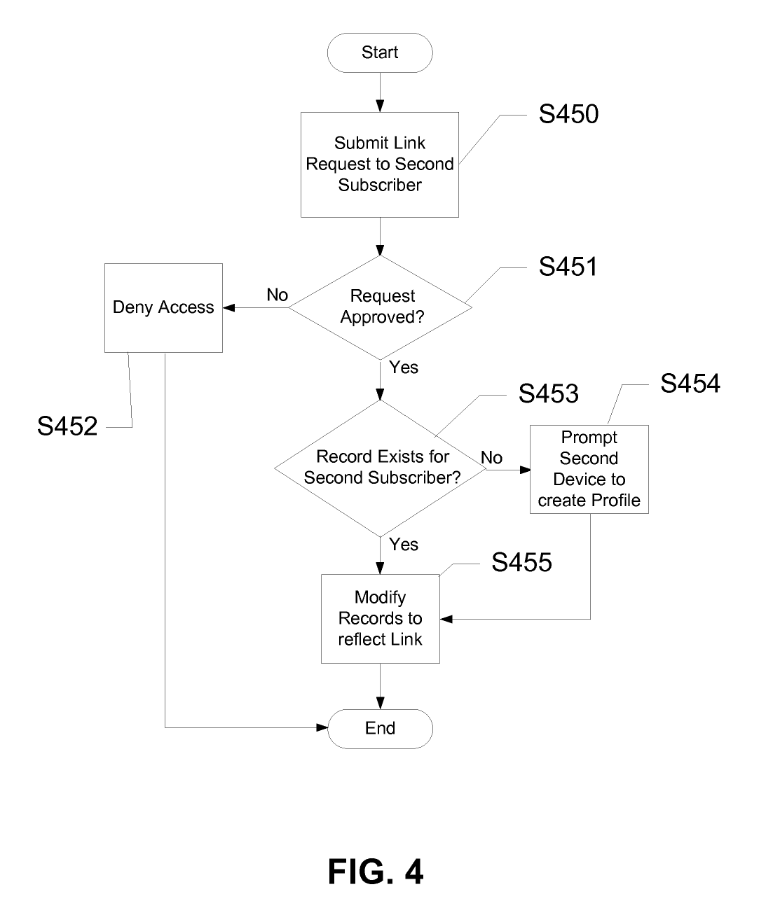

FIG. 4 shows a method for creating links between two subscribers, according to an exemplary embodiment of the present invention. It is to be assumed that the first subscriber has registered his information with application server via an application or web-based interface on his device. The first subscriber then sends a message to a second subscriber requesting the creation of a relationship (S450). This message may be a text message, or any equivalent message that can be considered a “link request.” There are several methods for creating a “link request” such as including a predefined alphanumeric string in a text, email, or equivalent message. Linking logic can receive origination information, destination information, and/or message characterization information pertaining to the link request from a billing server. The linking logic can also receive a message indicator that identifies the message as a link request from billing server 131. For instance, a billing server may recognize such an alphanumeric string, and forward the message to the linking logic in the application server. Consequently, linking logic recognizes the link request and awaits confirmation from the second subscriber.

The second subscriber has the ability to accept or deny the link request (S451). If the second subscriber denies the request, the first subscriber is denied a relationship with the second subscriber (S452). If the second subscriber accepts the link request, linking logic within the application server is configured to check the network addressbook database to see if a record exists for the second subscriber (S453). If not, then the second subscriber is prompted (S454) to create a profile/record within addressbook database. The second subscriber may additionally be prompted to download the application from an application server and provision his account with the local addressbook accordingly. If the second subscriber already has a profile, or once the profile is created, linking logic processes the link request by updating the profiles of the first subscriber to reflect a relationship or link with the unique user identity of the second subscriber (S455). Similarly, link logic updates the profile of the second subscriber to reflect a relationship or link with the unique user identity of the first subscriber.

The present invention also provides for automated linking based on a plurality of communications between two subscribers. A subscriber's record can be associated with a specific number of calls or other communications to a destination associated with a single unique identity. For example, a threshold tally count for a single destination subscriber can be set so that once this number of calls to the destination is reached, the destination address information is added to the subscriber's profile/record as a link. The tally count can be associated with a tally frequency so that the tally count threshold can be reached based on a number of contacts to a destination within a selected time period. In other examples, the subscriber's record can be updated based on, for example, time of call requests, or particular call destinations. For example, address or other information for destinations associated with a specified country code, area code, or local exchange code can be selected for inclusion or addition into the links/relationships section of a subscriber's record. As a specific example, calls to phone numbers having a particular prefix associated with, for example, a selected business or other institution, can be identified so that contact and address information for such numbers can be added to the subscriber's record after only one call request, or after a selected number of call requests that is less than a tally frequency threshold associated with other communication requests. Further, any communication established such as a voice session lasting more than a specified period can be stored in a call or billing log. The call/communication information can be received by a voice/messaging gateway that can transmit a message to the linking logic that includes address or contact data. This information can be based on billing information associated with the subscriber to linking logic at the application server. In some examples, an MSISDN serves as a communication source or destination identifier. Other identifiers can be used such as, for example, an international mobile subscriber identity (IMSI), an international mobile equipment identity (IMEI), email addresses, domain names, web addresses, PSTN telephone numbers, or other communication source or destination identifiers. In additional examples, contact data gathering can be executed and gathered data stored based on, for example, a common message recipient for emails, faxes, and other communications. A tally count can be based on communications to a recipient, even if the recipient is associated with several subscriber identifiers. A subscriber can then be prompted to add contacts based on the gathered data.

FIGS. 5A and 5B show two methods for populating an address book or other database with updated information from one subscriber, according to an exemplary embodiment of the present invention. Once it is established that both subscribers have records within the addressbook database and that a relationship or link is created within the record of each subscriber, the present invention is able to automatically update the local copies of the addressbook databases at each subscriber's devices. Referring to FIG. 5A, a first user updates his record on the network addressbook database (S550). For instance, if the subscriber decides to move to a new area code, or purchase a new device to add to his arsenal of devices, this new information can be updated by subscriber in his profile or record in the addressbook database. This update can be performed via the addressbook application on his device, or alternatively via a web interface that is accessed via his devices. Optionally a confirmation message can be relayed to subscriber that the update is successful. Following this, updating logic on the application server reviews the record for the first subscriber to determine all existing relationships/links with other subscribers (S551). If the first subscriber is linked to another subscriber (as described above and in FIG. 5A) then the updating logic retrieves this link information from the record of the first subscriber, and updates the local copy of the addressbook database stored on any device associated with the second subscriber (S552). Specifically, the updating logic can access the addressbook by accessing a SIM card, smart card, or equivalent module on the second subscriber's devices, and amend the addressbook file to reflect the new changes by the first subscriber. The method then ends (S553).

Alternatively, FIG. 5B shows another method to update a subscriber's addressbook, according to an exemplary embodiment of the present invention. The second subscriber may have programmed his addressbook application on his devices to regularly download updated information from the network addressbook database. In this case, after checking for relationships in the first subscriber's record (S560), updating logic awaits or checks for an update request from the addressbook application on the second subscriber's devices (S561). When an update is due or requested by the device, the updating logic will add the new information to local addressbook database (S562). This can either be done by updating logic accessing the second subscriber's SIM cards, or by the second subscriber's devices being permitted to access the network addressbook database. Either way, changes by one subscriber are automatically reflected in local address books of all other subscribers having links to the one subscriber.

In addition, the present invention offers an alternative to Number Portability, in that a subscriber that switches carriers (for instance from Verizon to AT&T) and wishes to retain his telephone number can simply enable the application on the new device, and all the subscriber's contacts will automatically be updated onto the new device. This update could occur automatically, via the application, or via the network. Furthermore, in addition to contact detail updates, the present invention also provides for the ability to share presence information for a contact. Presence includes availability to open a voice or data connection, as well as location information for a contact (such as location derived from an Assisted GPS (AGPS) receiver on the contact's mobile device). This location information can be added to a special field in the contact's record in the addressbook, and shared with other contacts.

The particular examples described above are illustrative of address book autopopulation and other methods and apparatus associated with providing data to an address book or revising or updating address book data. It will be apparent that these examples can be modified in arrangement and detail, and I claim all that is encompassed by the appended claims.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for automatically updating an address for a subscriber, the system comprising:
a first communication device on a network, the first communication device being associated with a first subscriber of the network and having a first address on the network;
a second communication device on the network, the second communication device being associated with a second subscriber of the network and having a second address on the network;
an application server on the network that hosts an addressbook application, the application server being in communication with an addressbook database on the network, wherein the addressbook database stores at least the first and second addresses and associates them with the first and second subscribers; and
linking logic on the application server that creates a link between the first and second subscriber based on a communication between the first and second subscriber;
wherein a modification of the first address on the addressbook database by the first subscriber results in a subsequent modification of the first address within a local copy of the addressbook database stored on a memory on the second device associated with the second subscriber.

2. The system of claim 1, wherein the addressbook database on the network comprises a plurality of records for a plurality of subscribers on the network, each record having a plurality of addresses for a plurality of devices associated with a subscriber of the network, each record further having a unique identifier for the subscriber of the network.

3. The system of claim 2, wherein the unique identifier is any combination of: an email address, a social security number, a first and a last name, and a date of birth.

4. The system of claim 1, wherein the communication between the first and second subscriber comprises a text message, the text message including a link request to be approved by the second subscriber.

5. The system of claim 4, wherein the linking logic retrieves the communication from a billing record for the first or the second subscriber.

6. The system of claim 1, wherein the communication between the first and second subscriber comprises a link request submitted to the second subscriber via the application server.

7. The system of claim 6, wherein the linking logic creates the link by modifying the addressbook database on the network, the modification comprising adding the unique identifier of the second subscriber in a contact field in the record for the first subscriber, and adding the unique identifier of the first subscriber in a contact field in the record for the second subscriber.

8. The system of claim 1, wherein the modification of the first address is performed via a local copy of the addressbook application stored on a memory on the first device.

9. The system of claim 1, wherein the modification of the first address is performed via a web interface.

10. The system of claim 1, wherein the subsequent modification of the local copy of the addressbook database is performed by an updating logic on the application server, the updating logic modifying the local copy of the addressbook database over the network.

11. The system of claim 1, wherein the subsequent modification of the local copy of the addressbook database is performed by an updating logic on the second mobile device, the updating logic modifying the local copy of the addressbook database by retrieving the updated addressbook database from the network.

12. The system of claim 1, further comprising a permissions field in the record for each subscriber, the permissions field enabling the first subscriber to add a permission for the second subscriber to retrieve the record of the first subscriber from the addressbook database from the network.

13. A method for automatically updating an address for a contact, the method comprising:
storing a first record for a first subscriber on a network and a second record for a second subscriber on the network, the first and second records being stored in an addressbook database in communication with an application server on the network, wherein each record includes at least a unique identifier for the subscriber on the network, and an address of a device associated with the corresponding subscriber on the network;
creating a link between a first subscriber and the second subscriber based upon a communication between a first address of a first device associated with the first subscriber and a second address of a second device associated with the second subscriber;
modifying the record for the first subscriber on the addressbook database on the network; and
subsequently modifying a record for the first subscriber on a local copy of the addressbook database stored on a memory within the second device associated with the second subscriber.

14. The method of claim 13, further comprising: registering the first subscriber with the application server, wherein the registering further comprises creating a record for the first subscriber in the addressbook database on the network.

15. The method of claim 13, wherein the unique identifier is any combination of: an email address, a social security number, a first and a last name, and a date of birth.

16. The method of claim 13, wherein the communication between the first and second subscriber comprises a text message, the text message including a link request to be approved by the second subscriber.

17. The method of claim 16, wherein creating a link further comprises retrieving the communication from a billing record for the first or the second subscriber.

18. The method of claim 13, wherein creating the link further comprises modifying the addressbook database on the network by adding the unique identifier of the second subscriber in a contact field in the record for the first subscriber, and adding the unique identifier of the first subscriber in a contact field in the record for the second subscriber.

19. The method of claim 13, wherein subsequently modifying the local copy of the addressbook database comprises modifying the local copy of the addressbook database over the network, or modifying the local copy of the addressbook database by retrieving the updated addressbook database from the network.

20. A computer program product stored on a computer readable medium on a network, the computer program product embodying logic that performs the steps of: storing a first record for a first subscriber on a network and a second record for a second subscriber on the network, the first and second records being stored in an addressbook database in communication with an application server on the network, wherein each record includes at least a unique identifier for the subscriber on the network, and an address of a device associated with the corresponding subscriber on the network; creating a link between a first subscriber and the second subscriber based upon a communication between a first address of a first device associated with the first subscriber and a second address of a second device associated with the second subscriber; modifying the record for the first subscriber on the addressbook database on the network; and subsequently modifying a record for the first subscriber on a local copy of the addressbook database stored on a memory within the second device associated with the second subscriber.
